(19) United States
(12) Patent Application Publication
(10) Pub. No.: US 2002/0077783 A1
(43) Pub. Date: Jun. 20, 2002

(54) Method for measuring computer output device performance

(76) Inventor: Emad M. Awadalla, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/746,939

(22) Filed: Dec. 19, 2000

(51) Int. Cl. G06F 11/30

(52) U.S. Cl. 702/186; 702/187

(57) ABSTRACT

Method and apparatus for measuring the performance of a computer output device, such as a printer, comprising encoding the data with a first code as it is transmitted from an originating computer to the output device, encoding the data at the conclusion of its processing by the output device with a second code, creating a data packet of performance measuring data including at least the first and second codes, transmitting the data packet for processing by an application resident in a report generating computer, and preparing a perceptible report on the performance of the output device, containing at least the first and second codes.

### FIELD OF THE INVENTION

The present invention relates to computer output devices, such as, for example, a printer, and more specifically to a process for generating performance data for that output device, including the time that transmitted data spends in a queue, number of copies, average processing time per page, guaranteed output device reports, billing information and the like.

### BACKGROUND OF THE INVENTION

In computer network installations, a multiplicity of work stations and computers are typically served by one or more network printers or other output devices. The effectiveness of the system is a function of many things, but certainly the efficiency of performance of the device is an important key to the competency of the output of the network or any computers in the network. Being able to determine the time a particular job remains in an output device queue will become a factor in determining whether the number of output devices that serve a set of computers is sufficient. Obtaining information about other aspects of the various device's function, such as number of print copies processed and average processing time per page also can serve to evaluate the performance of the system and its components. The prior art does not provide means or methods for accomplishing these measurements and obtaining a report from within the system of the output device.

### SUMMARY OF THE INVENTION

The invention applies to any output device for a computer, however to simplify the description, the invention will be described in terms of a typical printer as the output device.

The software that implements the inventive process will ultimately reside in the client, or originating, PC, the output device and a computer configured to prepare a report on the performance of the output device. The computer that generates this report can be the originating computer or it can be a file server that communicates with the output device.

The process begins by first encoding each page of originated data rendered by the printer driver with a code that is preferably a time stamp quantity. The encoded data is then transmitted to the printer where it enters a queue. Once the printer firmware starts to interpret the data to be printed, it also creates a data packet that includes, for example, a second code that is preferably a time stamp quantity, corresponding to the time of completion of the processing of the originated data by the printer. In addition to indicating the difference between the first and second time stamps the data packet may also include items of output device performance measurement such as the number of pages and copies processed, an authentication of the printing activity, pricing or billing information and other factors of choice.

The data packet prepared by the printer is then routed to a report generating application that will reside in either the originating PC that generated the originating data transfer or in a file server associated with the output device. With the packet of returned measurement data, the application residing in either the originating PC or the file server will generate the desired report of performance data for the output device.

### DESCRIPTION OF THE DRAWINGS

FIG. 1 is a flow diagram of the steps of the process of the present invention.

FIG. 2 is a block diagram of the system components that interact to perform the steps of the process where the report of the output device performance is generated in the client or originating PC.

FIG. 3 is a block diagram of the system components that interact to perform the steps of the process where the report of the output device performance is generated in a file server.

FIG. 4 is a more detailed block diagram of the system components that perform the process with the computer that caries the report generating application being generically referred to as a report generator.

### DETAILED DESCRIPTION OF THE INVENTION

The present invention comprises a process that is implemented by computer software. The process can function with a variety of computer system components including a client computer that originates or initiates a data string, an output device that processes the data string and a typical file server. For purposes of this description, the client computer will be defined as the computer that generates the data string that is to be further processed by the output device. Output devices of the type contemplated by this invention include, but are not limited to printers or other types of target device such as, for example, a copy machine. Printers will be the type of output device discussed in the description of the invention, but it is understood that the basic concepts of the invention can be applied to other output devices 2 whose performance lends itself to measurement and analysis.

The results of the performance measurements made by the process of the present invention are produced by a report generating application 5 that resides in either the originating PC 4, or, in the case of a network system, in the file server 6. Regardless of where the performance calculating portion of the software resides, the process of the invention is essentially the same, except for the routing of the measurement data that is contained in a data packet prepared as part of the process.

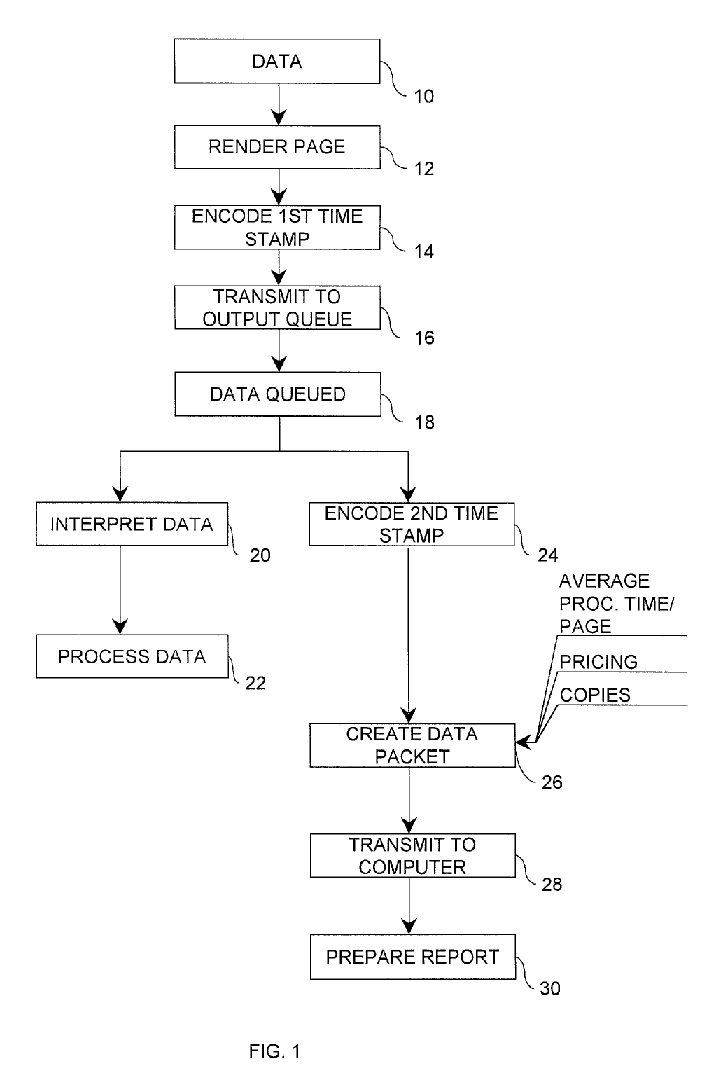

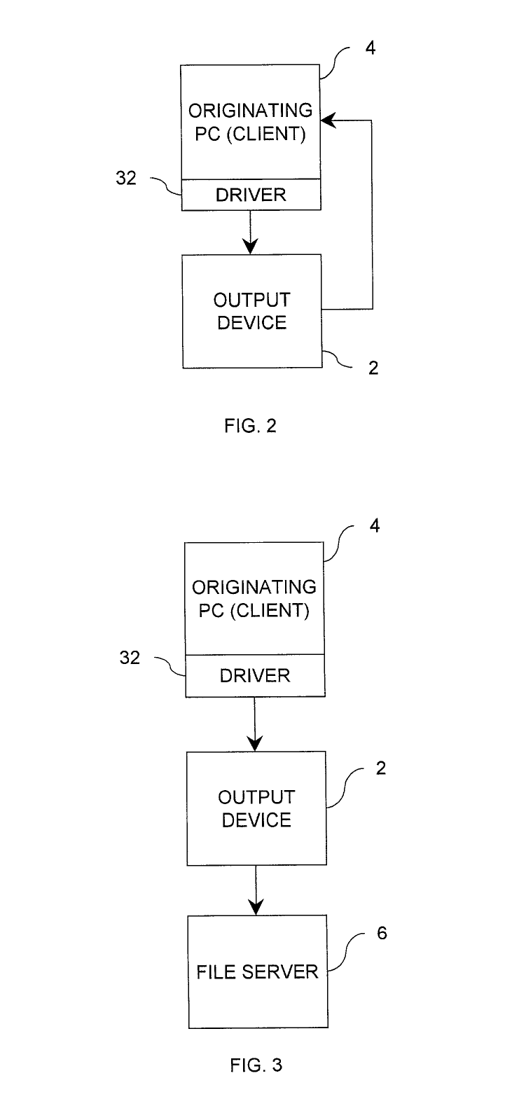

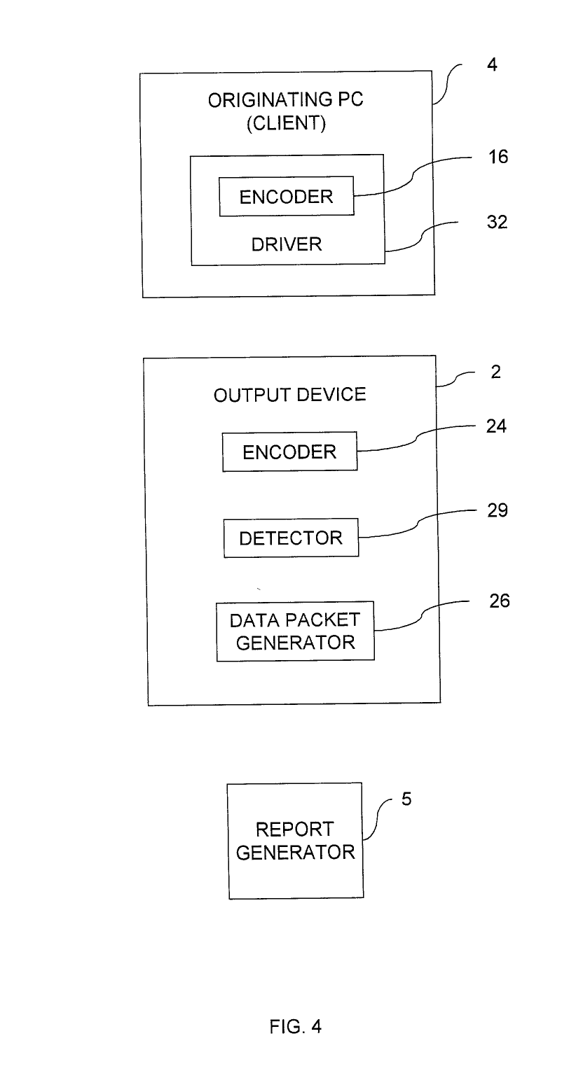

A flow diagram of the preferred form of the inventive process is seen in FIG. 1 of the drawings. Data 10, in the form of graphics, text or other format is prepared in the originating, or client, PC 4. With known techniques the data 10 is sent to the printer driver 32 where the data is rendered (converted to printable form) in a step identified by reference numeral 12. Each page of the rendered data is time stamped 14 with an encoding symbol that is not necessarily related to real time.

Following the first stamping of the data with a time related quantity the data is transmitted at step 16 to the printer 2 where it enters a queue 18. In its normal function, the printer interprets the initiated data at step 20 and prints it at 22. In accordance with the principals of the present invention, in a parallel process, the initiated data is encoded with a second stamping of a time quantity 24 which, with the first time quantity stamping, will indicate the time that the print job remained in the printer's queue before being processed. Following the second time stamping of the data an information packet is prepared at 26 including at least the time differential between the first and second time stampings. The information packet can also include such other data as is required under the circumstances to measure whatever other aspects of the performance is desired. These other measurements may include average time per page to process, guaranteed printing data, number of copies processed, billing and pricing information and others. This additional measurement data is accumulated by a portion of the inventive software that will be referred to as the detector 29.

After the packet of measurement information data is created at 26, the packet is transmitted 28 back to the originating computer 4 or to a file server 6. An application 5 resident therein will create a report 30 detailing the measurements of performance that were inputted to the data packet.

What is claimed is:

1. A method for measuring the performance of a computer output device comprising:
(a) encoding the data with a first code as it is transmitted from the output device driver of an originating computer to the output device;
(b) encoding the data at the conclusion of its processing by the output device with a second code;
(c) creating a data packet comprising at least the first and second codes;
(d) transmitting the data packet for processing by an application resident in a report generating computer; and
(e) preparing a perceptible report containing at least the first and second codes.

2. The method of claim 1 where the first and second codes are time quantity stamps.

3. The method of claim 1 where the transmission of the data packet is made to an application resident in the originating computer.

4. The method of claim 1 where the transmission of the data packet is made to an application resident in a file server.

5. The method of claim 1 where the step of preparing a data packet further includes the detection of performance characteristics of the output device.

6. The method of claim 5 where the detection of performance characteristics includes counting the copies processed by the output device.

7. The method of claim 5 where the detection of performance characteristics includes making pricing notations related to the processing by the output device.

8. The method of claim 5 where the detection of performance characteristics includes averaging the output device processing time per page.

9. A system for measuring the performance of a computer output device comprising:
(a) an originating computer for initiating data and having an output device driver;
(b) an output device connected to the output device driver;
(c) a first encoder associated with the driver for marking the data with a first code;
(d) a second encoder associated with the output device for marking the data with at least one second code;
(e) a report generator computer having an application configured to generate a report on the performance of the output device; and
(f) a code packet generator connected to the output device and configured to transmit a data packet containing at least the codes implemented by the first and second encoders to the report generating computer.

10. The system of claim 9 where the report generating computer is the originating computer.

11. The system of claim 9 and further including a file server connected to the output device.

12. The system of claim 11 where the report generating computer is the file server.

13. The system of claim 9 where the output device is a printer.

14. The system of claim 9 where the first and second codes are time quantity stamps.

15. The system of claim 9 and further including a detector, having an output, for monitoring selected performance characteristics of the output device, said output connected to the code packet generator.

16. A program storage device readable by a computer, tangibly embodying a program, applet, or instructions executable by the computer to perform a process comprising;
(a) receiving data in an output device that is encoded with a first code;
(b) encoding the data at the conclusion of its processing by the output device with a second code;
(c) preparing a data packet comprising at least the first and second codes; and
(d) transmitting the data packet to a report generating application.

17. The program storage device of claim 16 where the first and second codes are time quantity stamps.

18. The program storage device of claim 16 where the transmission of the data packet is made to an application resident in a computer from which the data was received.

19. The program storage device of claim 16 where the transmission of the data packet is made to an application resident in a file server.

20. The program storage device of claim 16 where the preparation of a data packet further includes the detection of selected performance characteristics of the output device.

21. The program storage device of claim 20 where the detection of performance characteristics includes counting the copies processed by the output device.

22. The program storage device of claim 20 where the detection of performance characteristics includes making pricing notations related to the processing by the output device.

23. The program storage device of claim 20 where the detection of performance characteristics includes averaging the output device processing time per page.
